(19) United States
(12) Patent Application Publication
(10) Pub. No.: US 2004/0120359 A1
(43) Pub. Date: Jun. 24, 2004

(54) Method and system for conducting digital real time data processing

(76) Inventors: Rudi Frenzel, Munich (DE); Wolfgang Glatt, Munich (DE); Jain Raj Kumar, Singapore (SG); Markus Terschluse, Munich (DE); Stefan Uhlemann, Munich (DE)

Correspondence Address: FISH & RICHARDSON PC, 225 FRANKLIN ST, BOSTON, MA, 02110, US

(21) Appl. No.: 10/469,492

(22) PCT Filed: Feb. 26, 2002
(86) PCT No.: PCT/EP02/02045

(30) Foreign Application Priority Data
Mar. 1, 2001 (DE) 101099746

(51) Int. Cl. H04J 3/04

(52) U.S. Cl. 370/535

(57) ABSTRACT

Digital real-time data processing system which processes digital input data streams received from a plurality of digital data sources (4) to produce digital output data streams and sends them to digital data sinks (32), the digital data processing system (1) having:

(a) at least one controllable multiplexer (13) having a plurality of inputs (12) to which a respective received digital input data stream is applied;

(b) at least one clocked data processing unit (17) for data processing the digital input data stream sent from an output (14) on the multiplexer,

the data processing unit (17) being clocked with a clock signal whose clock frequency corresponds to the product of the maximum data transmission rate (Rₘₐₓ) of all the input and output data streams and the number (N) of data sources and data sinks;

(c) at least one controllable demultiplexer (25) via whose outputs (29) the processed data are sent to the digital data sinks (32) as the digital output data streams;

(d) a control unit (20) for actuating the multiplexer (13), the demultiplexer (25) and the digital data processing unit (17),

where the control unit (20) connects the inputs (12) on the multiplexer to a data input (16) on the data processing unit (17) cyclically for a respective constant time fraction (Tᵢ) of the cycle time (T_{cycle}),

where the control unit connects the outputs (29) on the demultiplexer (25) to the associated digital data sink (32) cyclically for the respective constant time fraction (Tᵢ),

where the control unit (20) activates the data processing unit (17) for data processing the data, connected by the multiplexer (13), in a digital input data stream received at a particular data transmission rate for a respective variable data processing time (T_{active}).

The invention relates to a method and a system for digital real-time data processing of a plurality of digital input data streams which have different data transmission rates.

In many digital data processing systems for testing and communication technology, a single electronic data processing unit is used for data processing a plurality of digital input data streams in a time-division multiplex method. The data processing unit captures the different digital input data streams from any digital data sources, such as analog sensors with analog/digital converters connected downstream, carries out the data processing and sends the processed data to data sinks as digital output data streams.

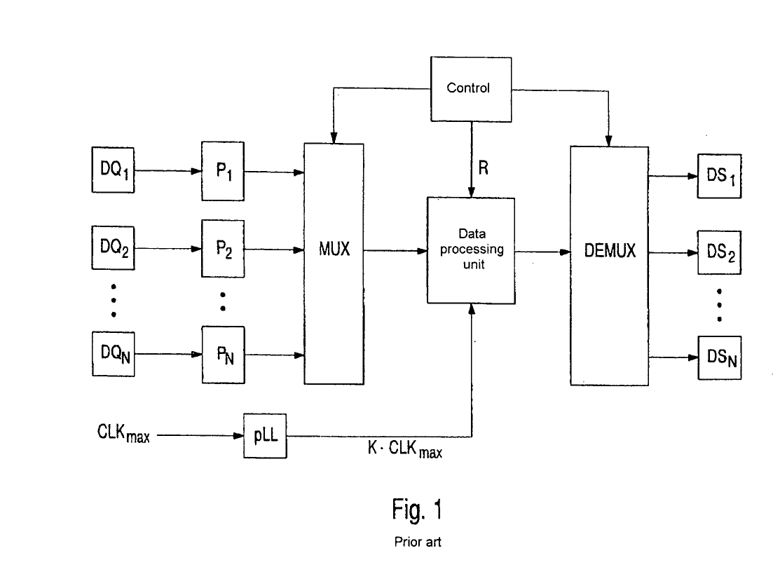

FIG. 1 shows a first digital real-time data processing system based on the prior art. A plurality of data sources DQ send digital input data streams which are buffered in associated input buffer stores in the digital real-time data processing system. The buffered data are sent from a buffer to an input of a multiplexer which is actuated by a controller. On the output side, the multiplexer is connected to a clocked data processing unit. The buffered data from the various data sources are connected cyclically to the input of the data processing unit, which carries out the digital data processing. The data from the various data sources DQ are supplied to the data processing unit in blocks in this case, are digitally processed by the data processing unit and are sent in blocks to various data sinks DS via a demultiplexer. The input buffer stores P are required if the digital data sources DQ deliver a continuous digital data stream. In this case, the buffer stores P buffer the data from the individual data sources over that period of time which is required for the data processing unit to data process the data from the remaining data sources.

The data processing unit is clocked by a clock signal via a clock input. In the case of the real-time data processing system based on the prior art as shown in FIG. 1, the data streams from the digital data sources DQ have the same data transmission rates. In this case, the data processing unit is clocked with a clock signal whose clock frequency corresponds to a multiple of the maximum data transmission rate.

In the case of the digital real-time data processing system based on the prior art as shown in FIG. 1, the data processing unit is connected to each of the inputs of the multiplexer or to each of the outputs of the demultiplexer cyclically for the same period of time every time. In the case of this conventional digital real-time data processing system, the controller shown in FIG. 1 can be in the form of a simple counter. The data processing unit carries out continuous data processing and is reset to a particular initial state via a reset line R whenever the multiplexer changes over. The data processing unit is, by way of example, a programmable digital signal processor for a multichannel digital audio system. The conventional digital real-time data processing system shown in FIG. 1 can only be used for input data streams which all have the same data transmission rate, however.

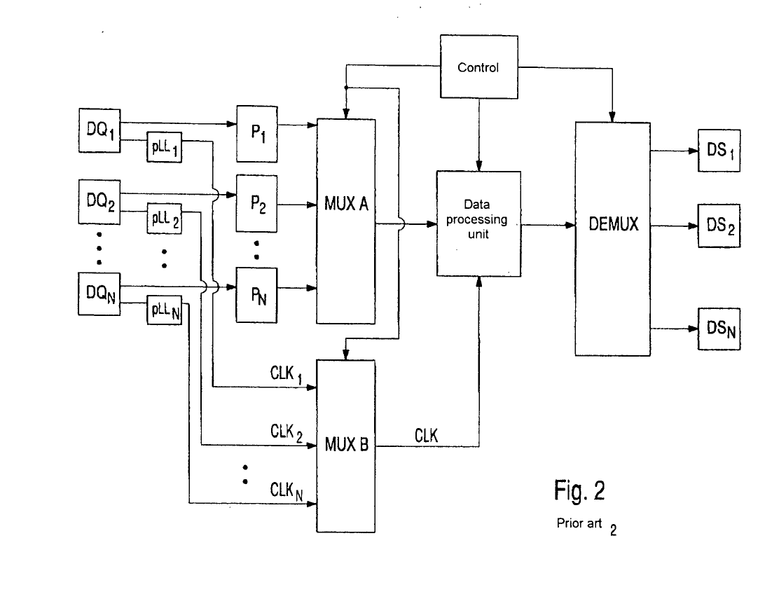

FIG. 2 shows another digital real-time data processing system based on the prior art, in which the digital data sources DQ have different data transmission rates. The digital data sources DQ have data transmission rates which are independent of one another, and they deliver a reference signal which indicates the respective data transmission rate, for example a clock signal. The clock frequency of the various clock signals is matched to the data processing speed of the data processing unit by a frequency multiplication circuit, for example a PLL circuit, and is passed to an associated input on a further multiplexer MUXB. The controller cyclically connects a digital input data stream via a multiplexer MUXA and, at the same time, the associated matched clock signal via a second multiplexer MUXB to the data processing unit. The data processing unit then data processes the applied digital input data stream, the data processing unit being clocked with a clock signal whose clock frequence corresponds to the digital input data stream's data transmission rate matched to the data processing speed.

The disadvantage of the digital real-time data processing system based on the prior art, as shown in FIG. 2, is that the clock signal for clocking the data processing unit needs to be generated using complex-circuitry clock multiplication circuits, such as phase locked loops PLL. In this case, a separate clock multiplication circuit PLL needs to be provided for each data source, since only in rare cases is a common multiple of all the data transmission rates involved available as a reference signal. The circuitry of the phase locked loops PLL is relatively complex, since they contain a tunable oscillator. In integrated circuits, such analog components as a tunable oscillator place great demands on the manufacturing technology used and thus result in relatively high manufacturing costs. In addition, a stable, jitter-free clock signal can be delivered by a PLL circuit only with a high level of circuit complexity, which means that the power and surface requirements for this are also relatively high. Since phase locked loops PLL have a finite locking time, a separate phase locked loop needs to be provided for each digital data source, which means that, with 32 digital data sources DQ, for example, 32 phase locked loops are also needed in the conventional digital real-time data processing system, as illustrated in FIG. 2.

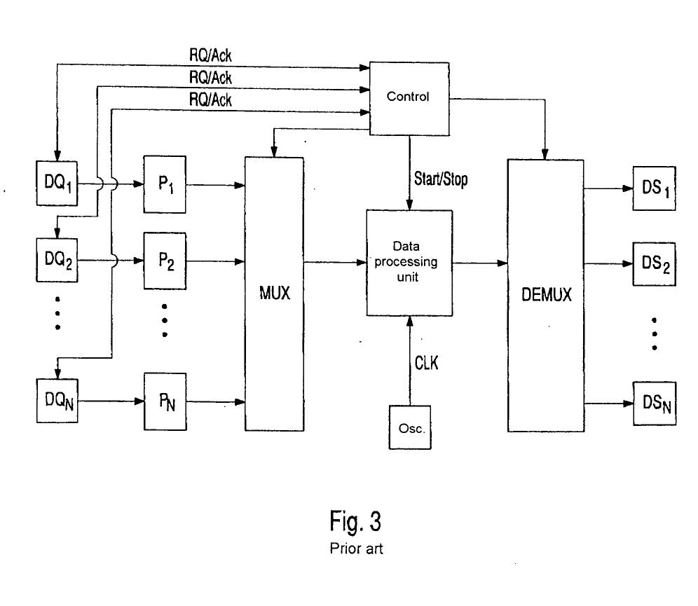

FIG. 3 shows a third digital real-time data processing system based on the prior art. In the case of this digital real-time data processing system based on the prior art, the digital data sources DQ request processing time from the data processing unit independently of one another. The request is made by a control signal sent by the data source DQ. Alternatively, it is also possible for the data processing unit to indicate the availability of data processing time to the various digital data sources, which then provide the data.

The disadvantage of the digital real-time data processing system based on the prior art as shown in FIG. 3 is the very high level of control complexity, since independent data processing operations need to be prioritized and handled in succession by the data processing unit. In the case of the digital real-time data processing system based on the prior art, as shown in FIG. 3, the controller needs to manage the data processing requests received and to stipulate an order for the data processing by the data processing unit. In this case, the data transmission rate of the data received from a data source DQ governs varying data processing times obtained, so that the buffer stores have to have relatively large memory sizes. The signals for the data processing request are either generated by the data sources DQ themselves or are ascertained from the data filling states of the buffer stores. The implementation of such a digital real-time data processing system requires a very high level of circuit complexity which even exceeds the circuit complexity for the actual data processing unit.

It is therefore the object of the present invention to provide a method and a system for digital real-time data processing which are able to process a plurality of input data streams having different data transmission rates while at the same time having a low level of circuit complexity.

The invention achieves this object by means of a digital real-time data processing system having the features specified in Patent claim 1 and by a method for digital real-time data processing having the features specified in Patent claim 15.

The invention provides a digital real-time data processing system which processes digital input data streams received from a plurality of digital data sources to produce digital output data streams and sends them to digital data sinks,

the digital data processing system having:

(a) a plurality of input buffer stores which each buffer the data in a received digital input data stream;

(b) at least one controllable multiplexer whose input is respectively connected to an input buffer store;

(c) at least one clocked data processing unit for data processing the buffered data sent from an output on the multiplexer,

the data processing unit being clocked with a clock signal whose clock frequency corresponds to the product of the maximum data transmission rate of all the input and output data streams and the number of data sources and data sinks;

(d) at least one controllable demultiplexer via whose outputs the processed data are sent to the digital data sinks as digital output data streams; and

(e) a control unit for actuating the multiplexer, the demultiplexer and the data processing unit,

where the control unit connects the inputs of the multiplexer to the associated buffer store cyclically for a respective constant time fraction of the cycle time,

where the control unit connects the outputs of the demultiplexer to the associated digital data sink cyclically for the respective constant time fraction, and

where the control unit activates the data processing unit for data processing the data, connected by the multiplexer, in a digital input data stream received at a particular data transmission rate for a respective variable data processing time.

In this case, the control unit in the inventive digital real-time data processing system calculates the data processing time preferably such that the ratio between the data processing time and the maximum constant time fraction of the cycle time available is equal to the ratio between the data transmission rate of the digital input data stream to be processed and the maximum data transmission rate of all the input and output data streams.

In a preferred further embodiment, the control unit in the inventive digital real-time data processing system activates the data processing unit for data processing the data, connected by the multiplexer, in a digital input data stream for a first number of cycles and deactivates the data processing unit for a second number of cycles, the ratio between the number of deactivated cycles and the number of activated cycles being dependent on the ratio between the maximum transmission rate of all the input and output data streams and the data transmission rate of the digital input data stream which is to be processed.

The control unit in the inventive digital real-time data processing system deactivates the data processing unit preferably after the data processing time has elapsed.

In one preferred embodiment of the inventive digital real-time data processing system, the processed data sent from the outputs on the demultiplexer are buffered in output buffer stores.

The data processing unit [sic] deactivates the data processing unit for data processing the data in a digital input data stream preferably if the detected data filling state of the associated output buffer store exceeds a settable threshold value.

In one particularly preferred embodiment of the inventive digital real-time data processing system, the control unit deactivates the data processing unit by actuating a switching device which interrupts the clock signal for clocking the data processing unit.

In one preferred embodiment of the inventive digital real-time data processing system, the digital input data streams are delivered by analog/digital converters.

In one particularly preferred embodiment of the inventive digital real-time data processing system, the input buffer stores are swinging buffers or ring buffers.

The number of digital data sources is preferably equal to the number of digital data sinks.

In one preferred embodiment of the inventive digital real-time data processing system, said system contains a clock-signal generation circuit which detects the data transmission rate of all the digital input streams and of all the digital output data streams and generates a clock signal whose clock frequency corresponds to the maximum detected data transmission rate.

In one preferred embodiment of the inventive digital real-time data processing system, a frequency multiplication circuit is also provided which multiplies the generated clock frequency of the clock signal sent by the clock-signal generation circuit by a constant factor in order to generate a clock signal for clocking the data processing unit.

In this case, the factor preferably corresponds to the number of data sources and to the number of data sinks.

The invention also provides a method for digital real-time data processing of data which are sent by a number of digital data sources, having the following steps:

(a) a plurality of digital input data streams having different data transmission rates are received from the data sources;

(b) the received digital input data streams are buffered in associated input buffer stores;

(c) all the received digital input data streams are cyclically processed by a data processing unit,

the data processing unit being clocked with a clock signal whose clock frequency corresponds to the product of the maximum data transmission rate of all the input and output data streams and the number of digital data sources, and

the respective processing time for processing a digital input data stream being variably adjusted;

(d) the processed digital input data streams are output to digital data sinks as digital output data streams.

Preferred embodiments of the inventive digital real-time data processing system and of the inventive method for digital real-time data processing are described below with reference to the appended figures in order to explain fundamental features of the invention.

In the figures:

FIG. 1 shows a first digital real-time data processing system based on the prior art;

FIG. 2 shows a second digital real-time data processing system based on the prior art;

FIG. 3 shows a third digital real-time data processing system based on the prior art;

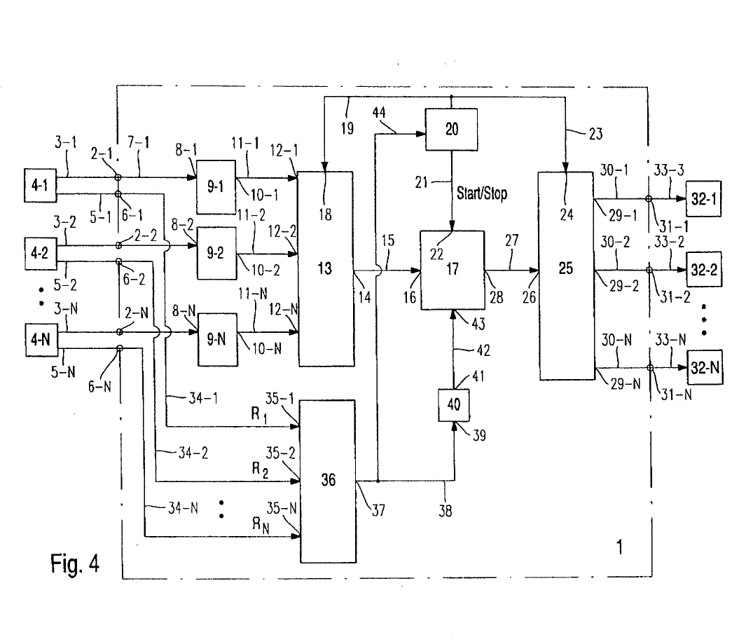

FIG. 4 shows a first embodiment of the inventive digital real-time data processing system;

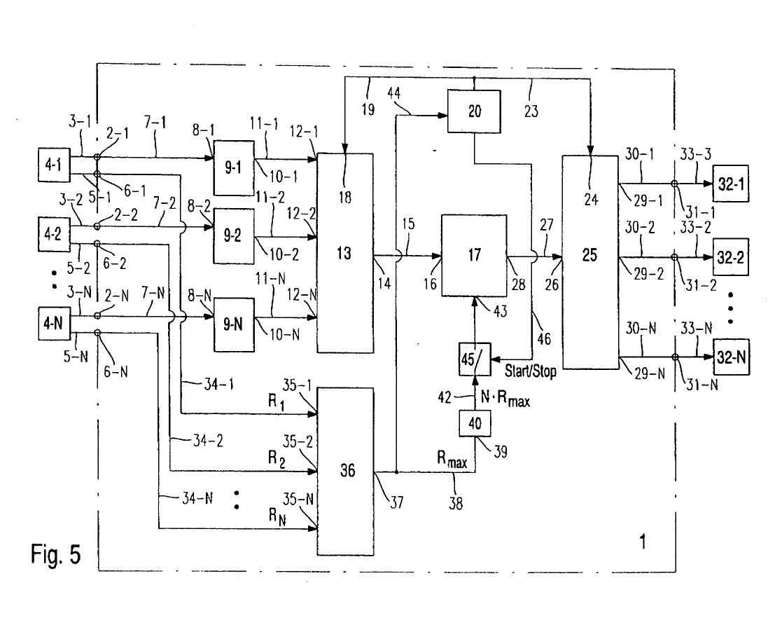

FIG. 5 shows a second embodiment of the inventive digital real-time data processing system;

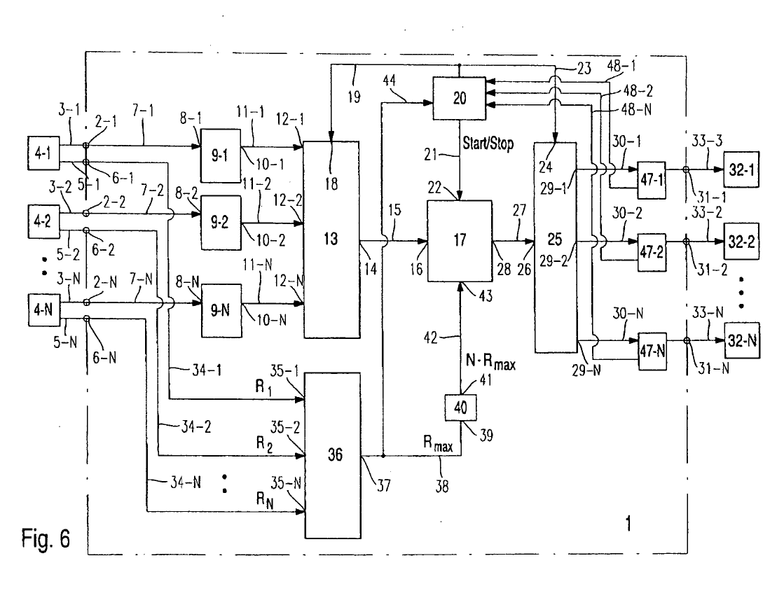

FIG. 6 shows a third embodiment of the inventive digital real-time data processing system;

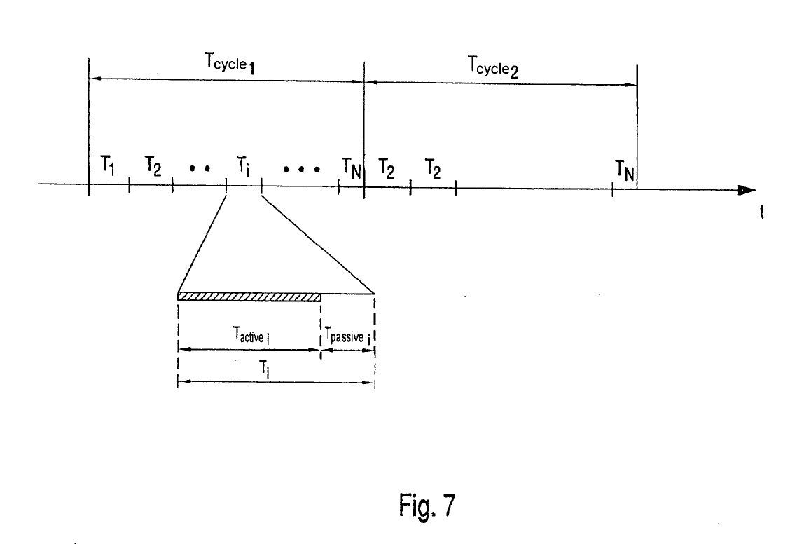

FIG. 7 shows a timing diagram to explain the way in which the inventive digital real-time data processing system works;

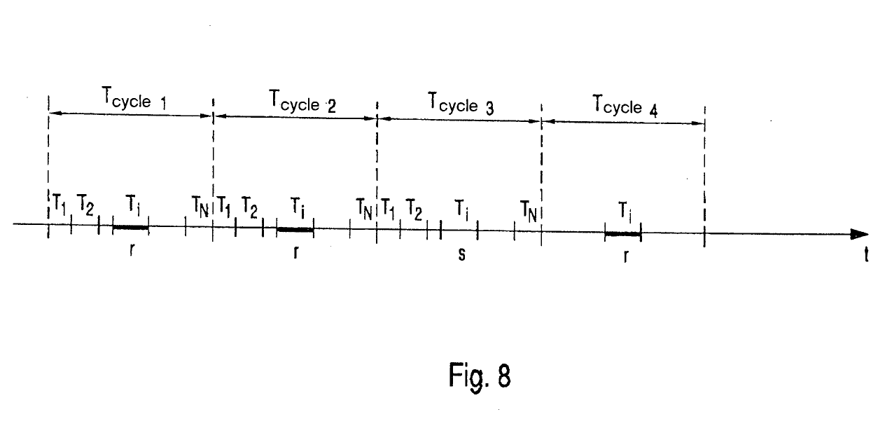

FIG. 8 shows another timing diagram to explain the way in which an alternative embodiment of the digital real-time data processing system based on the invention works;

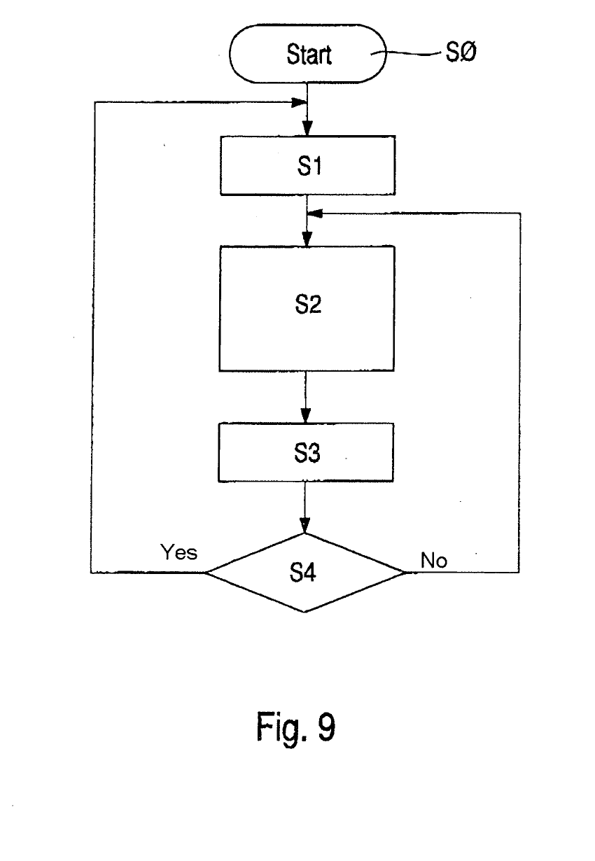

FIG. 9 shows a first flowchart to explain the inventive digital real-time data processing method;

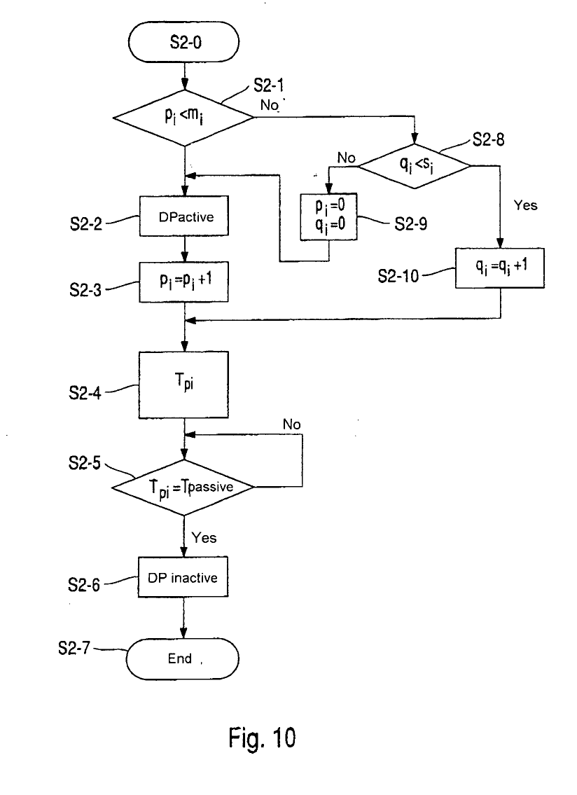

FIG. 10 shows another flowchart to explain a preferred embodiment of the inventive real-time data processing method.

FIG. 4 shows a first embodiment of the digital real-time data processing system based on the invention. The input side of the digital real-time data processing system 1 is connected via data inputs 2 to digital data sources 4, which intermittently or continuously send a digital data stream, by means of data lines 3 or data buses 3. The digital data sources 4 send a digital data stream having different data transmission rates R. In a first embodiment of the inventive digital real-time data processing system 1, the data rates of the various digital input data streams are prescribed. In an alternative embodiment, the digital data sources on it generate a respective reference signal whose clock frequency corresponds to the data transmission rate of the associated data stream. This reference signal is applied by the digital data source to a reference signal input 6 on the digital real-time data processing system 1 via a line 5.

The data inputs 2 are connected to an input 8 on an input buffer store 9 by means of internal data lines or a databus 7. Each input buffer store 9 buffers the data in the received digital input data stream and sends them to an input 12 on a controllable multiplexer 13 via an output 10 by means of a databus 11. The buffer stores 9 or data rate converters 9 are not absolutely necessary, but rather are provided preferably when the digital data sources 4 deliver a continuous data stream. The multiplexer 13 has a signal output 14 which is connected to a data input 16 on the data processing unit 17 by means of a data line or by means of a databus 15. The multiplexer 13 also has a control input 18 which is actuated via a control line 19 by a control unit 20 in the digital real-time data processing system 1. In addition, the control unit 20 is connected by means of a control line 21 to a control input 22 on the data processing unit 17 and by means of a control line 23 to a control input 24 on a demultiplexer circuit 25. The demultiplexer circuit 25 has a signal input 26 which is connected to a data output 28 on the digital data processing unit 17 by means of data lines or a databus 27. The demultiplexer 25 has a plurality of outputs 29 which are connected by means of data lines or data buses 30 to data outputs 31 on the digital real-time data processing system 1. The data outputs 31 have digital data sinks 32 connected to them by means of data lines or buses 33.

In the embodiment shown in FIG. 1, the data transmission rates of the various digital data sources 4 are not stipulated, and the digital real-time data processing system ascertains the maximum applied data transmission rate from the reference signals which are applied to the reference signal inputs 6. To this end, the reference signal inputs are connected to inputs 35 on a clock-signal generation circuit 36 by means of lines 34. From the applied reference clock signals, whose clock frequency respectively corresponds to the associated data transmission rate, the clock-signal generation circuit 36 generates that reference signal whose clock frequency corresponds to the maximum detected data transmission rate. This clock signal is sent by the clock-signal generation circuit 36 to a signal input 39 on a frequency multiplication circuit 40, for example a PLL circuit, via an output 37 and a line 38.

The frequency multiplication circuit 40 increases the clock frequency of the applied clock signal by a constant factor which corresponds [sic] preferably equal to the number N of data sources 4 connected to the digital real-time data processing system 1 or to the number of digital data sinks 32. The clock signal sent by the frequency multiplication circuit 40 via a signal output 41 is passed via a clock line 42 to a clock input 43 on the data processing unit 17. The data processing unit 17 is thus clocked with a clock signal whose clock frequency corresponds to the product of the maximum data transmission rate of all the input data streams and the number N of connected digital data sources 4 or digital data sinks 32. In another embodiment, the data transmission rates of the output data streams are additionally detected by the clock-signal generation circuit 36, with the clock-signal generation circuit 36 sending a clock signal whose clock frequency corresponds to the product of the maximum data transmission rate of all the input and output data streams and the number of connected data sources 4 or data sinks 32.

In one preferred embodiment of the inventive digital real-time data processing system 1, the various data transmission rates of the input data streams which are sent by the digital data sources 4 and the data transmission rates of the output data streams which are sent to the data sinks 32 are prescribed, and the clock signal for clocking the digital data processing unit 17 is generated in an oscillator circuit which sends a clock signal having a clock frequency which corresponds to the product of the prescribed maximum data transmission rate of all the input and output data streams and the number of data sources 4 or data sinks 32.

The embodiment of the digital real-time data processing system 1 which is shown in FIG. 4 allows the use of the data processing system also when there are digital data sources whose data transmission rates are not known.

The control unit 20 undertakes actuation of the multiplexer 13, of the demultiplexer 25 and of the data processing unit 17. The control unit 20 actuates the multiplexer 13 via the control line 19 such that the signal inputs 12 on the multiplexer 13 are cyclically connected to the signal output 14 on the multiplexer 13. Within a cycle, first the input 12-1 and then the further inputs 12-2, 12-3 to 12-N on the multiplexer 13 are connected, and then the connection cycle is repeated as often as desired. The cycle time is constant in this case. Each input is connected to the output 14 on the multiplexer 13 and hence to the data input 16 on the data processing unit 17 for a particular constant time fraction. At the same time, the control unit 20 connects the signal input 26 on the demultiplexer 25 cyclically to the data outputs 29-1 to 29-N via the control line 23. In addition, the control unit uses a control line 21 to activate the digital data processing unit 17 for data processing the connected data stream applied to the data input 16, which data stream is received at a respective particular data transmission rate, for a variable data processing time.

In the case of the embodiment of the inventive data processing system 1 which is shown in FIG. 4, the control unit 20 calculates the data processing time such that the ratio between the data processing time and the maximum constant time fraction of the cycle time available is equal to the ratio between the data transmission rate of the digital input data stream which is to be processed and the maximum data transmission rate of all the input and output data streams.

FIG. 7 shows a timing diagram to explain the way in which the inventive digital data processing system 1 works. The various digital input data streams coming from the N digital data sources 4 are cyclically connected to the data input 16 on the digital data processing unit by the multiplexer 13, with the cycle time T_{cycle} being constant, so that a constant time fraction Tᵢ of the cycle time T_{cycle} is available for the data processing unit 17 to data process a channel or a digital input data stream.

In a first embodiment, the data processing unit 17 is activated for data processing by the control unit 20 via the control line 21 at the start of each time fraction and is deactivated after an ascertained variable data processing time for this channel via the control line 21.

The following apply:

$${T}_{cycle} = {\sum }_{i = 1}^{N} {T}_{i} = constant \qquad ( 1 )$$

T₁=T_{active}_{ᵢ}+Tₚₐₛₛᵢᵥₑ_{ᵢ}=constant (2)

In the case of the embodiment shown in FIG. 4, the control unit 20 calculates the active data processing time T_{active}_{ᵢ} for the ith digital input data stream on the basis of the following equation:

$${T}_{{active}_{i}} = \frac{{R}_{i}}{{R}_{max}} \cdot {T}_{i} \qquad ( 3 )$$

where Rᵢ is the data transmission rate of the digital input data stream which is currently to be processed, and Rₘₐₓ is the maximum data transmission rate of all the digital input and output data streams. The maximum digital data transmission rate Rₘₐₓ is either known in advance and is stored in the control unit 20 or is read in via a line 44 from the clock-signal generation device 36 by the control unit 20 in the embodiment shown in FIG. 4. The data transmission rate Rᵢ of the digital input data stream which is currently to be processed is likewise either known in advance or is read into the reference signal inputs 6 by the control unit 20.

FIG. 7 shows another alternative way in which the inventive real-time data processing system works. In the case of this embodiment, the real-time data processing system's input side has the input data buffers shown in FIG. 4, which means that it is possible to stretch the disconnection operation for a digital input data stream to a complete time fraction Tᵢ of the cycle time T_{cycle} and still to ensure real-time processing. The advantage of the procedure illustrated in FIG. 8 is that the number of start and stop operations in the data processing unit is greatly reduced as compared with the procedure shown in FIG. 7.

As FIG. 8 shows, the digital input data stream i is activated during the first two cycles for the overall maximum available time period Tᵢ, i.e. for the total available time fraction of the cycle time, for example, and is deactivated completely in the third cycle. The ratio between the number of time fractions Tᵢ activated in succession and the number of time fractions Tᵢ subsequently deactivated is ascertained by the control unit 20, where the following is true:

$$\frac{{S}_{i}}{{r}_{i}} = \frac{{R}_{max}}{{R}_{i}} - 1 \qquad ( 4 )$$

where

S indicates the number of inactive time sections (stop) and

R indicates the number of active time sections (run).

During the active time fractions R, the data processing unit 17 operates at the maximum clock frequency, which corresponds to the maximum transmission rate Rₘₐₓ.

The memory size mᵢ of each input data buffer store 9 which is required in order to buffer the volume of data is in this case at least:

mᵢ=(1+sᵢ)·N·Tᵢ·Rᵢ (5)

As soon as the input buffer store 9 is idle, the preferred embodiment of the inventive data processing system involves the data processing of a [lacuna] for this channel being deactivated for s cycles, so that the input buffer store 9 fills up again.

In this case, the number of deactivated cycles is preferably 1.

The embodiment described in connection with FIG. 8 is advantageously used whenever the data processing unit needs to access data blocks of the same size for each input channel at different data transmission rates rᵢ, as in the case of an N.FFT transformation with fixed n, for example. In one particularly preferred embodiment, this involves the data filling state of the input data buffers 9 being monitored by the control unit 20. If the data filling state of the data buffer on the input side drops below a threshold value in this case, the data processing unit 17 is deactivated in the next cycle for the associated time fraction.

FIG. 5 shows another embodiment of the inventive digital data processing system 1, which is very largely based on the embodiment shown in FIG. 4. In the case of the embodiment shown in FIG. 5, a switching unit 45 is additionally provided which is actuated by the control unit 20 using a control line 46. In the case of the embodiment shown in FIG. 5, the digital data processing unit 17 is activated and deactivated by turning the clock signal applied to the clock signal input 43 on and off.

FIG. 6 shows another embodiment of the inventive data processing system 1, in which the variable data processing time for the various input channels is ascertained by the control unit 20 from the data filling states of additionally provided output data buffers 47-1 to 47-N. In this case, the digital data processing unit 17 is deactivated by the control unit 20 via the control line 21 if the detected data filling state of the associated output data buffer 47 exceeds a settable threshold value. The data filling state of an output data buffer store 47 is reported to the control unit 20 via an associated line 48. As soon as a volume of data Tᵢ·Rᵢ has been stored in the output buffer store 47, the data processing unit 17 is disconnected for the rest of the time fraction Tᵢ.

FIG. 9 shows a timing diagram to explain the inventive method for digital real-time data processing. After a starting step S0, a channel counter is initialized or set to 0 in step S1. In a subprogram S2, which is shown in FIG. 10, the ith input data stream is data processed by the data processing unit 17, and the channel counter is incremented in a step S3. In a step S4, a check is carried out to determine whether all the input data streams have been processed within a cycle or whether or not the channel counter has reached the maximum channel number N. If all the input data streams have been processed within a cycle, the process returns to step S1, so that the next cycle can start. In the converse situation, the data processing takes place for the next input channel or for the next digital input data stream.

FIG. 10 shows a preferred embodiment of the subprogram S2 shown in FIG. 9. In a step S2-1, a check is carried out to determine whether or not a counter p is less than the ascertained number of active time cycles r for the ith channel. If the necessary number for the active time fraction Tᵢ has not yet been reached, the data processing unit 17 is activated for data processing in a step S2-2 and the error p is incremented in a step S2-3. In a step S2-4, a passive time counter Tₚ is activated, and in a step S2-5, . . . a check is carried out to determine whether or not the rest of the passive time Tₚₐₛₛᵢᵥₑ has elapsed. When the rest of the passive time Tₚₐₛₛᵢᵥₑ and hence the time fraction Tᵢ has elapsed, the data processing unit 17 is deactivated in a step S2-6 and the subprogram is exited in a step S2-7.

If step S2-1 establishes that the necessary number of active time cycles for this channel has already been reached, a check is carried out in a step S2-8 to determine whether or not the number of necessary inactive (stop) cycles has been reached. If the counter q has reached the necessary number s of inactive cycles, the two counters p, q are reset in a step S2-9. Conversely, the counter q is incremented for the inactive cycles in a step S2-10 without the data processing unit 17 being activated.

The inventive digital real-time data processing system can be used both for digital data sources with constant data transmission rates known in advance and for data sources whose data transmission rates vary. Brief interrupts in the data processing by the data processing unit 17, which in the active state operates at the highest data transmission rate which can be expected, connect the data processing unit in a time-division multiplex mode to the digital data sources which have different data transmission rates without the need for any controller having complex circuitry.

The fixed time frame results in equal data propagation times for the various data sources with a minimal memory size for the buffer stores.

In the case of the embodiment shown in FIG. 5, the data processing is interrupted through disconnection of the operating clock, which means that this embodiment is distinguished by particularly low power consumption. The inventive digital real-time data processing system can be used particularly advantageously for applications in which various digital data sources with slightly different data transmission rates exist. Such applications are particularly difficult to implement with the prior art. The buffer stores are preferably in the form of swing buffer stores or in the form of ring buffer stores. In the case of one embodiment for data block processing, the buffer stores are not necessary.

List of References

1 Digital data processing system

2 Data input

3 Data line

4 Digital data source

5 Line

6 Reference signal input

7 Line

8 Input

9 Input buffer store

10 Output

11 Line

12 Multiplexer input

13 Multiplexer

14 Multiplexer output

15 Line

16 Data input

17 Data processing unit

18 Control input

19 Control line

20 Control unit

21 Control line

22 Control input

23 Control line

24 Control input

25 Demultiplexer

26 Demultiplexer input

27 Line

28 Data output

29 Demultiplexer output

30 Line

31 Data output

32 Data sink

33 Data line

34 Reference signal line

35 Input

36 Clock-signal generation circuit

37 Output

38 Line

39 Input

40 Frequency multiplication circuit

41 Output

42 Line

43 Clock input

44 Line

45 Switching device

46 Control line

47 Output data buffer.

48 Line

1. Digital real-time data processing system which processes digital input data streams received from a plurality of digital data sources (4) to produce digital output data streams and sends them to digital data sinks (32), the digital data processing system (1) having:
(a) at least one controllable multiplexer (13) having a plurality of inputs (12) to which a respective received digital input data stream is applied;
(b) at least one clocked data processing unit (17) for data processing the digital input data stream sent from an output (14) on the multiplexer,
the data processing unit (17) being clocked with a clock signal whose clock frequency corresponds to the product of the maximum data transmission rate (Rₘₐₓ) of all the input and output data streams and the number (N) of data sources and data sinks;
(c) at least one controllable demultiplexer (25) via whose outputs (29) the processed data are sent to the digital data sinks (32) as the digital output data streams;
(d) a control unit (20) for actuating the multiplexer (13), the demultiplexer (25) and the digital data processing unit (17),
where the control unit (20) connects the inputs (12) of the multiplexer to a data input (16) on the data processing unit (17) cyclically for a respective constant time fraction (Tᵢ) of the cycle time (T_{cycle}),
where the control unit connects the outputs (29) of the demultiplexer (25) to the associated digital data sink (32) cyclically for the respective constant time fraction (Tᵢ),
where the control unit (20) activates the data processing unit (17) for data processing the data, connected by the multiplexer (13), in a digital input data stream received at a particular data transmission rate for a respective variable data processing time (T_{active}).

2. Digital real-time data processing system according to claim 1,
characterized
in that a plurality of input buffer stores (9) are provided which each buffer the data in a received digital input data stream.

3. Digital real-time data processing system according to claim 1 or 2,
characterized
in that the control unit (20) calculates the data processing time such that the ratio between the data processing time and the maximum constant time fraction of the cycle time available is equal to the ratio between the data transmission rate (Rᵢ) of the digital input data stream to be processed and the maximum data transmission rate (Rₘₐₓ) of all the input and output data streams.

4. Digital real-time data processing system according to one of the preceding claims,
characterized
in that the control unit (20) activates the data processing unit (17) for data processing the data, connected by the multiplexer, in a digital input data stream for a first number (r) of cycles and deactivates for a second number (s) of cycles, the ratio between the number (s) of deactivated cycles and the number (r) of activated cycles being dependent on the ratio between the maximum data transmission rate (rₘₐₓ) and the data transmission rate (Rᵢ) of the digital input data stream.

5. Digital real-time data processing system according to one of the preceding claims,
characterized
in that the control unit (20) deactivates the digital data processing unit (17) after the data processing time has elapsed.

6. Digital real-time data processing system according to one of the preceding claims,
characterized
in that the processed data sent from the outputs (29) of the demultiplexer are buffered in output buffer stores (47).

7. Digital real-time data processing system according to one of the preceding claims,
characterized
in that the control unit (20) deactivates the digital data processing unit (17) for data processing the data in a digital input data stream if a detected data filling level in the associated output buffer store (47) exceeds a settable threshold value.

8. Digital real-time data processing system as claimed in one of the preceding claims,
characterized
in that the control unit (20) deactivates the data processing unit (17) by actuating a switching device (45) for interrupting the clock signal which clocks the digital data processing unit (17).

9. Digital real-time data processing system according to one of the preceding claims,
characterized
in that the digital input data streams are sent by analog/digital converters.

10. Digital real-time data processing system according to one of the preceding claims,
characterized
in that the buffer stores are swinging buffers or ring buffers.

11. Digital real-time data processing system according to one of the preceding claims,
characterized
in that the number of digital data sources (4) is equal to the number of digital data sinks (47).

12. Digital real-time data processing system according to one of the preceding claims,
characterized
in that the data transmission rates of the input and output data streams are different.

13. Digital real-time data processing system according to one of the preceding claims,
characterized
in that a clock-signal generation circuit (36) detects the data transmission rates of all the digital input data streams and of all the digital output data streams and generates a clock signal whose clock frequency corresponds to the maximum detected data transmission rate (Rₘₐₓ).

14. Digital real-time data processing system according to one of the preceding claims,
characterized
in that a frequency multiplication circuit is provided which multiplies the clock frequency of the clock signal sent by the clock-signal generation circuit (36) by a constant factor in order to generate the clock signal for the data processing unit (17).

15. Digital real-time data processing system according to claim 14,
characterized
in that the factor corresponds to the number of digital data sources (4) and to the number of digital data sinks (47).

16. Method for digital real-time data processing of data which are sent by a number of digital data sources (4), having the following steps:
(a) a plurality of digital input data streams having different data transmission rates are received from various digital data sources (4);
(b) all the received digital input data streams are cyclically processed by a digital data processing unit (17),
the data processing unit (17) being clocked with a clock signal whose clock frequency corresponds to the product of the maximum data transmission rate (Rₘₐₓ) of all the input and output data streams and the number (N) of digital data sources and digital data sinks, and the respective data processing time for processing a digital input data stream being variably adjusted;
(c) the processed digital input data streams are output to digital data sinks (32) as digital output data streams.
